(19) United States
(12) Patent Application Publication
(10) Pub. No.: US 2022/0130573 A1
(43) Pub. Date: Apr. 28, 2022

(54) ELECTRIC CABLE

(71) Applicant: Dongguan Luxshare Technologies Co., Ltd, Dongguan City (CN)

(72) Inventors: ZhongChao PENG, Dongguan City (CN); JinChang DAI, Dongguan City (CN); HuanZhong YAN, Dongguan City (CN); BenTao HU, Dongguan City (CN); Charles Lloyd Grant, MILPITAS, CA (US); Andrew John Nowak, MILPITAS, CA (US)

(73) Assignee: Dongguan Luxshare Technologies Co., Ltd, Dongguan City (CN)

(21) Appl. No.: 17/376,374

(22) Filed: Jul. 15, 2021

(30) Foreign Application Priority Data
Oct. 22, 2020 (CN) 202022368545.1

(51) Int. Cl. H01B 7/08; H01B 7/02; H01B 11/00; H01B 11/06; H01B 3/44

(52) U.S. Cl. CPC H01B 7/0838; H01B 7/0208; H01B 3/445; H01B 11/06; H01B 11/002

(57) ABSTRACT

The present disclosure provides an electric cable, comprising two signal conductors, a resin insulating layer, an expanded polytetrafluoroethylene insulating film, an electromagnetic shielding film, two ground conductors, and a covering layer. The resin insulating layer covers the two signal conductors. The expanded polytetrafluoroethylene insulating film covers the resin insulating layer. The electromagnetic shielding film covers the expanded polytetrafluoroethylene insulating film. The two ground conductors are disposed at two sides of the electromagnetic shielding film. The cladding layer clads the electromagnetic shielding film and the two ground conductors. Through the expanded polytetrafluoroethylene insulating film, the electric cable can be applied to compact products, and the electric cable can be highly flexible such that the signal transmission performance would not be affected after being repeatedly bent.

### CROSS-REFERENCE TO RELATED APPLICATION

This application claims the priority benefit of Chinese Patent Application Serial Number 202022368545.1, filed on Oct. 22, 2020, the full disclosure of which is incorporated herein by reference.

### BACKGROUND

### Technical Field

The present disclosure relates to the technical field of cable, particularly to an electric cable.

### Related Art

Conventional electric cables comprise two signal cores, a shielding layer, and a cladding layer. Each of the signal cores is manufactured by cladding a signal conductor with an insulating layer. Since the insulating layer is considerably thick, the electric cable is bulky with poor flexibility. When the cable has been repeatedly bent, the signal conductors of the electric cable are prone to be damaged, resulting in poor signal transmission performance of the cable during the signal transmission process, which does not satisfy the requirements for compact size and low loss.

### SUMMARY

The embodiments of the present disclosure provide an electric cable tended to solve the problem that conventional electric cables present poor signal transmission performance and cannot be applied to compact products due to inner damages after the electric cables are bent in multiple times as they are bulky with poor flexibility.

The present disclosure provides an electric cable, comprising two signal conductors, a resin insulating layer, an expanded polytetrafluoroethylene insulating film, an electromagnetic shielding film, two ground conductors, and a covering layer. The resin insulating layer covers the two signal conductors. The expanded polytetrafluoroethylene insulating film covers the resin insulating layer. The electromagnetic shielding film covers the expanded polytetrafluoroethylene insulating film. The two ground conductors are disposed at the periphery of the electromagnetic shielding film. The cladding layer clads the electromagnetic shielding film and the two ground conductors.

In the embodiments of the present disclosure, by applying the expanded polytetrafluoroethylene insulating film, the thickness of the two resin insulating layers can be reduced to downsize the cable which allows the cable to be applied to compact products. Besides, since the expanded polytetrafluoroethylene insulating film has extremely low dielectric constant and high flexibility, the cable is highly flexible and the signal transmission performance of the cable would not be affected by repeated bending.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a perspective view of an electric cable of the first embodiment of the present disclosure;

FIG. 2 is a schematic diagram of the electric cable of the first embodiment of the present disclosure;

FIG. 3 is a perspective view of an electric cable of the second embodiment of the present disclosure;

FIG. 4 is a schematic diagram of the electric cable of the second embodiment of the present disclosure;

FIG. 5 is a schematic diagram of an electric cable of the third embodiment of the present disclosure; and

FIG. 6 is a schematic diagram of an electric cable of the fourth embodiment of the present disclosure.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

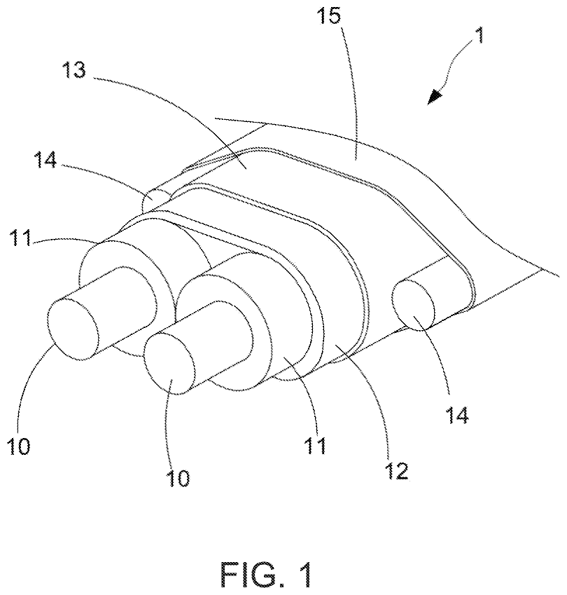

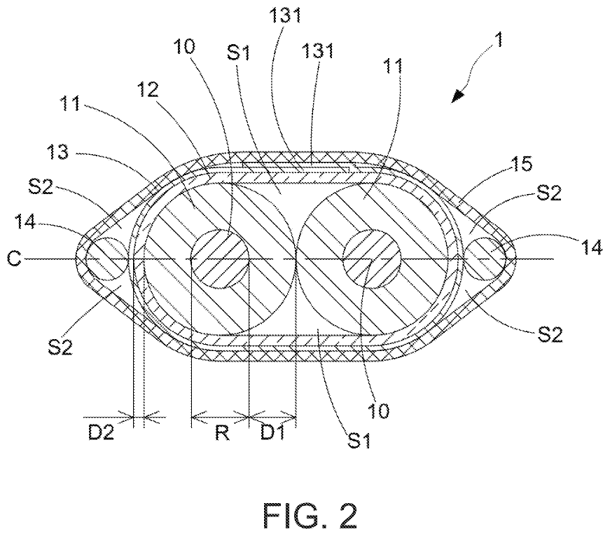

FIG. 1 and FIG. 2 are perspective view and schematic diagram of an electric cable of the first embodiment of the present disclosure. As shown in the figures, in this embodiment, the electric cable 1 comprises two signal conductors 10, two resin insulating layers 11, an expanded polytetrafluoroethylene insulating film 12, an electromagnetic shielding film 13, two ground conductors 14, and a cladding layer 15. The two resin insulating layers 11 respectively cover a side surface of any one of the two signal conductors 10. Two end surfaces of any one of the two signal conductors 10 are exposed from the resin insulating layer 11.

The expanded polytetrafluoroethylene insulating film 12 covers the two resin insulating layers 11 and covers a part of an outer surface of the two resin insulating layers 11. The two signal conductors 10 are disposed in the expanded polytetrafluoroethylene insulating film 12. At least one first elastic deformation space S1 exists between the expanded polytetrafluoroethylene insulating film 12 and the two resin insulating layers 11. In this embodiment, two opposite first elastic deformation spaces S1 exist between the expanded polytetrafluoroethylene insulating film 12 and the two resin insulating layers 11.

The electromagnetic shielding film 13 covers an outer surface of the expanded polytetrafluoroethylene insulating film 12. The two ground conductors 14 are disposed at the periphery of the electromagnetic shielding film 13 and are in contact with the electromagnetic shielding film 13. In this embodiment, the two ground conductors 14 are oppositely disposed with the electromagnetic shielding film 13 in between. Centers of the two signal conductors 10 and centers of the two ground conductors 14 are on the same line, which indicates that the centers of the two signal conductors 10 and the centers of the two ground conductors 14 are disposed on line C connecting the centers of the two signal conductors 10 (the centerline of the electric cable 1).

The cladding layer 15 clads the electromagnetic shielding film 13 and the two ground conductors 14 and covers a part of an outer surface of the electromagnetic shielding film 13 and a part of a side surface of the two ground conductors 14. In this embodiment, a plurality of second elastic deformation spaces S2 exist between the cladding layer 15, the electromagnetic shielding film 13, and the two ground conductors 14. The thickness D1 of the resin insulating layer 11 is thicker than or equal to the thickness D2 of the expanded polytetrafluoroethylene insulating film 12. A thickness D1 of the resin insulating layer 11 refers to the minimum distance between an inner surface of the resin insulating layer 11 adjacent to the signal conductor 10 and the outer surface of the resin insulating layer 11. A thickness D2 of the expanded polytetrafluoroethylene insulating film 12 refers to the minimum distance between an inner surface of the expanded polytetrafluoroethylene insulating film 12 adjacent to the resin insulating layer 11 and the outer surface of the expanded polytetrafluoroethylene insulating film 12. The thickness D1 of the resin insulating layer 11 is smaller than or equal to an outer diameter R of the signal conductor 10.

In this embodiment, the material of the resin insulating layer 11 (for example, polyethylene (PE), polypropylene (PP), or fluorinated ethylene propylene (FEP)), which is different from the material of the expanded polytetrafluoroethylene insulating film 12. Through the expanded polytetrafluoroethylene insulating film 12, the thickness of the two resin insulating layers 11 of the electric cable 1 could be reduced to effectively downsize the electric cable 1 for current demand on a compact size of devices.

Besides, the expanded polytetrafluoroethylene insulating film 12 has an extremely low dielectric constant and high flexibility. Meanwhile, as the thickness of the two resin insulating layers 11 is reducing, the electric cable 1 can be highly flexible to not affect the signal transmission performance even it is repeatedly bent. Meanwhile, through at least one first elastic deformation space S1 and the cladding layer 15 between the expanded polytetrafluoroethylene insulating film 12 and the two resin insulating layers 11 and the plurality of second elastic deformation spaces S2 between the electromagnetic shielding film 13 and the two ground conductors 14, when the electrical cable 1 is squeezed or bent, at least one first elastic deformation space S1 could provide a space for the expanded polytetrafluoroethylene insulating film 12 for deformation and a plurality of second elastic deformation spaces S2 provides a space for the cladding layer 15 for deformation without damaging the internal configuration of the electric cable 1 having the signal transmission performance to be kept excellent condition. Moreover, since the first elastic deformation space S1 and the second elastic deformation space S2 could provide an elastic margin for the electric cable 1 when it is bent, the signal conductor 10 can be protected from being damaged by bending and compressing.

In this embodiment, through the electromagnetic shielding film 13 and the two ground conductors 14, the two signal conductors 10 of the electric cable 1 can be protected from external electromagnetic interference during signal transmission, or to keep the electromagnetics generated during signal transmission from interfering with external devices. Meanwhile, the two signal conductors 10 form a differential signal pair, with which the electric cable 1 transmit differential signals. In this way, the interference generated by the two adjacent signal conductors 10 during the signal transmission process can be canceled to effectively increase the anti-interference ability of the electric cable 1, allowing the electric cable 1 to achieve the goal of low loss and to greatly improves the signal transmission performance, particularly the stable SI performance.

In this embodiment, the electromagnetic shielding film 13 comprises two connecting parts 131 respectively disposed at two ends of the electromagnetic shielding film 13. When the electromagnetic shielding film 13 covers the expanded polytetrafluoroethylene insulating film 12, the two connecting parts 131 would be connected in a stacked manner to secure the electromagnetic shielding film 13 onto the expanded polytetrafluoroethylene insulating film 12.

In this embodiment, the signal conductor 10 and the ground conductor 14 are both elongated cylinders or braided by a plurality of wires. The signal conductor 10 and the ground conductor 14 are both made of metals or metal alloys, which are selected from a group comprising copper, aluminum, tin, nickel, silver, and gold. Or, the signal conductor 10 and the ground conductor 14 are both plated with metal on a metal substrate, such as tin-plated copper or silver-plated copper. The resin insulating layer 11 is a tape and is spirally wound on a side surface of the signal conductor 10, and the tape is secured to the signal conductor 10 by adhesive. Or, the resin insulating layer 11 is formed by coating on the side surface of the signal conductor 10. The expanded polytetrafluoroethylene insulating film 12 is sheet-shaped, which could entirely cover the two resin insulating layers 11. The expanded polytetrafluoroethylene insulating film 12 can also be ribbon-shaped, which can be spirally wound on the two resin insulating layers 11. The electromagnetic shielding film 13 is a single electromagnetic shielding film layer. The material of the electromagnetic shielding film layer is metal, which is selected from a group comprising aluminum, copper, lead, and tin. The cladding layer 15 is made of polyethylene terephthalate (PET).

As shown in FIG. 2, the electric cable 1 of this embodiment covers a side surface of the two signal conductors 10 with two resin insulating layers 11. In other embodiments, the side surfaces of the two signal conductors 10 can be covered with one resin insulating layer 11, then the expanded polytetrafluoroethylene insulating film 12 could cover the resin insulating layer 11, which would not be repeated herein. In this embodiment, the centers of the two signal conductors 10 and the centers of the two ground conductors 14 are on a line C connecting the centers of the two signal conductors 10. The centers of the two ground conductors 14 could also be offset relative to the line C connecting the centers of the two signal conductors 10. The centers of the two ground conductors 14 could be on the same side of the line C connecting the centers of the two signal conductors 10, or the centers of the two ground conductors 14 are respectively on two sides of the line C connecting the centers of the two signal conductors 10 to present a misalignment arrangement.

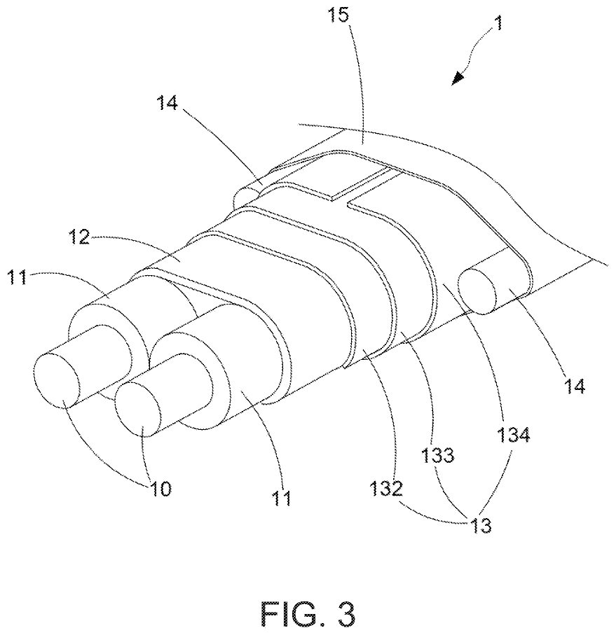

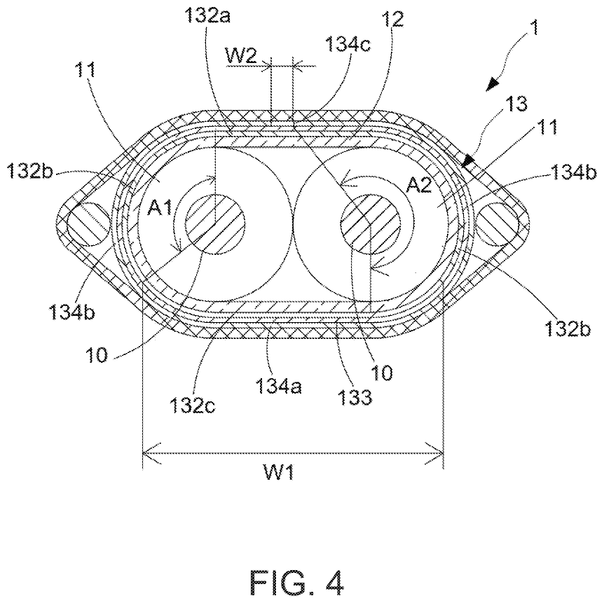

FIG. 3 and FIG. 4 are perspective view and schematic diagram of an electric cable of the second embodiment of the present disclosure. As shown in the figures, the electric cable 1 of this embodiment is different from that of the first embodiment in the structural configuration of the electromagnetic shielding film 13. In this embodiment, the electromagnetic shielding film 13 comprises a first electromagnetic shielding film layer 132, an insulating isolation layer 133, and a second electromagnetic shielding film layer 134. The insulating isolation layer 133 covers an expanded polytetrafluoroethylene insulating film 12, and two signal conductors 10 are disposed in the insulating isolation layer 133. The first electromagnetic shielding film layer 132 is disposed on an inner surface of the insulating isolation layer 133 and is disposed between the expanded polytetrafluoroethylene insulating film 12 and the insulating isolation layer 133. The second electromagnetic shielding film layer 134 is disposed on an outer surface of the insulating isolation layer 133 and is opposite to the first electromagnetic shielding film layer 132. The first electromagnetic shielding film layer 132 and the second electromagnetic shielding film layer 134 are disposed around the two signal conductors 10. The first electromagnetic shielding film layer 132 is closer than the second electromagnetic shielding film layer 134 to the two signal conductors 10, and the two ground conductors 14 are in contact with the second electromagnetic shielding film layer 134. The first electromagnetic shielding film layer 132 and the second electromagnetic shielding film layer 134 are made of metal, which are selected from a group comprising aluminum, copper, lead, and tin. The insulating isolation layer 133 is made of polyester.

In this embodiment, the first electromagnetic shielding film layer 132 comprises a first covering part 132a and two first cladding parts 132b. The two first cladding parts 132b are disposed on two sides of the first covering part 132a. A first gap 132c corresponding to the first covering part 132a exists between the two first cladding parts 132b. The second electromagnetic shielding film layer 134 comprises a second covering part 134a and two second cladding parts 134b. The two second cladding parts 134b are disposed on two sides of the second covering part 134a. A second gap 134c corresponding to the second covering part 134a exists between the two second cladding parts 134b. The first covering part 132a is closer than the two first cladding parts 132b to the second gap 134c, and the two first cladding parts 132b are closer than the first covering part 132a to the second covering part 134a. The two first cladding parts 132b partially overlap with the two second cladding parts 134b respectively. In this way, the first electromagnetic shielding film layer 132 and the second electromagnetic shielding film layer 134 would surround the expanded polytetrafluoroethylene insulating film 12, which also indicates that the two signal conductors 10 are surrounded by the first electromagnetic shielding film layer 132 and the second electromagnetic shielding film layer 134 to prevent the two signal conductors 10 from being interfered by external electromagnetics during signal transmission, or to keep the electromagnetic interference generated by the two signal conductors 10 during the signal transmission process from interfering with external devices. Thus, the electric cable 1 is well electromagnetically shielded to improve the signal transmission performance and to achieve the goal of low loss.

In this embodiment, the first cladding part 132b is arc-shaped. The center of the first cladding part 132b overlaps the center of the adjacent signal conductor 10. A central angle A1 the first cladding part 132b is greater than 10 degrees and smaller than 180 degrees. Similarly, the second cladding part 134b is arc-shaped. The center of the second cladding part 134b overlaps the center of the adjacent signal conductor 10. A central angle A2 of the second cladding part is greater than 10 degrees and smaller than 180 degrees. In this embodiment, the first electromagnetic shielding film layer 132 and the second electromagnetic shielding film layer 134 are partially overlapped, which can increase the anti-interference ability of the electric cable 1. The central angle A1 of the first cladding part 132b is smaller than the central angle A2 of the second cladding part 134b. The width W2 of the second gap 134c of the second electromagnetic shielding film layer 134 is narrower than the width W1 of the first gap 132c of the first electromagnetic shielding film layer 132. Two ends of the two second cladding parts 134b of the second electromagnetic shielding film layer 134 away from the second covering part 134a are very close to the second covering part 134a, which increases the area that the second electromagnetic shielding film layer 134 overlaps the first electromagnetic shielding film layer 132 to ensure that the first electromagnetic shielding film layer 132 and the second electromagnetic shielding film layer 134 can surround the two signal conductors 10 in the expanded polytetrafluoroethylene insulating film 12. In this way, the electric cable 1 can be well electromagnetically shielded to improve the signal transmission performance. In other embodiments, by adjusting the central angle A1 of the first cladding 132b and the central angle A2 of the second cladding part 134b, the width W2 of the second gap 134c of the second electromagnetic shielding film layer 134 could also be equal to or wider than the width W1 of the first gap 132c of the first electromagnetic shielding film layer 132. By allowing the first electromagnetic shielding film layer 132 to only partially overlap the second electromagnetic shielding film layer 134, the first electromagnetic shielding film layer 132 and the second electromagnetic shielding film layer 134 could surround the two signal conductors 10 in the expanded polytetrafluoroethylene insulating film 12 for the same effect as described above.

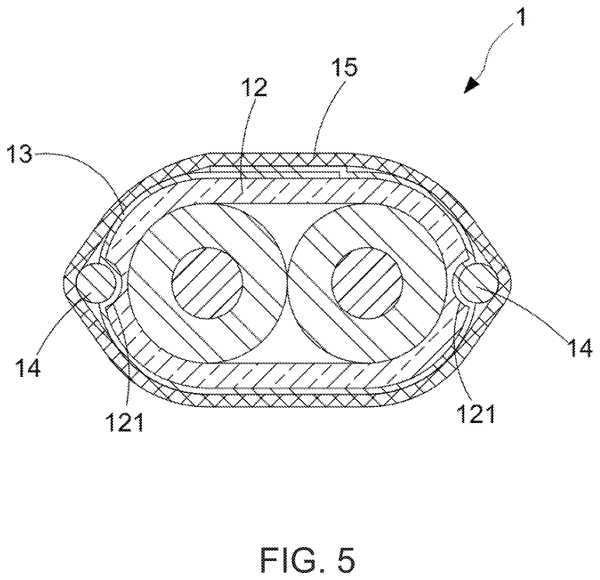

FIG. 5 is a schematic diagram of an electric cable of the third embodiment of the present disclosure. As shown in the figure, the electric cable 1 of this embodiment is different from that of the first embodiment in the structural configuration of the expanded polytetrafluoroethylene insulating film 12. In this embodiment, two positioning recesses 121 are provided at where the outer surface of the expanded polytetrafluoroethylene insulating film 12 corresponds to the two ground conductors 14. The cladding layer 15 is claded between the electromagnetic shielding film 13 and the two ground conductors 14. The two ground conductors 14 are respectively disposed in the two positioning recesses 121, so that the electromagnetic shielding film 13 is pasted on a sidewall of the two positioning recesses 121. That is, the electromagnetic shielding film 13 is disposed between the corresponding grounding conductor 14 and the positioning recess 121 to locate the two ground conductors 14 on the electromagnetic shielding film 13 and on the expanded polytetrafluoroethylene insulating film 12 for upcoming disposing of cladding layer 15.

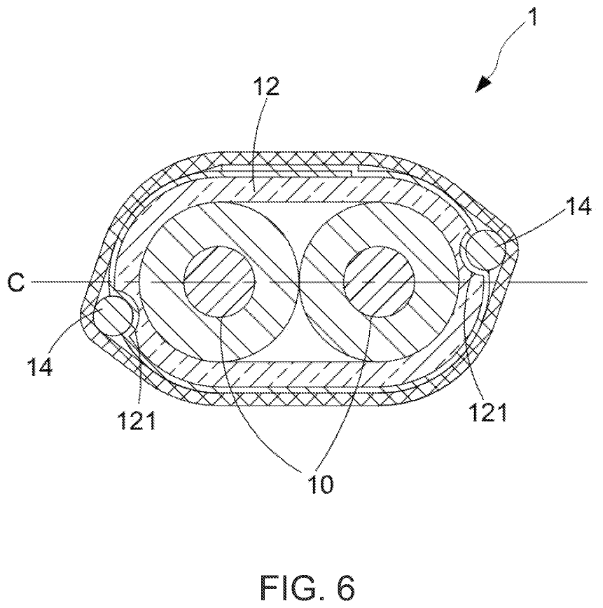

FIG. 6 is a schematic diagram of an electric cable of the fourth embodiment of the present disclosure. As shown in the figure, in this embodiment, except the position on an outer surface of an expanded polytetrafluoroethylene insulating film 12 corresponding to two ground conductors 14 comprises two positioning recesses 121, the two positioning recesses 121 are alternately arranged with respect to the line C connecting the centers of the two signal conductors 10. Since the two ground conductors 14 are respectively disposed in the two positioning recesses 121, the two ground conductors 14 are oppositely disposed on two sides of the line C connecting the centers of the two signal conductors 10, also forming an alternate arrangement. In this embodiment, such arrangement allows the electric cable 1 to be assembled with devices or equipment that needs to be installed on an inclined surface for the convenience of assembly. Besides, the effects of the first to third embodiments described above could also be performed by the configuration of this embodiment.

In summary, embodiments of the present disclosure provide an electric cable. By applying the expanded polytetrafluoroethylene insulating film, the thickness of the two resin insulating layers can be reduced to downsize the cable which allows the cable to be applied to compact products. Besides, since the expanded polytetrafluoroethylene insulating film has extremely low dielectric constant and high flexibility, the cable is highly flexible and the signal transmission performance of the cable would not be affected by repeated bending under the circumstances that the thickness of the two resin insulating layers is also reduced.

In the electric cable 1 of the present disclosure, the two signal conductors simultaneously form a differential signal pair through the electromagnetic shielding film and the two ground conductors. In this way, the interference generated by the two adjacent signal conductors during the signal transmission process can be canceled to effectively increase the anti-interference ability of the electric cable, allowing the electric cable to achieve the goal of low loss and to greatly improve the signal transmission performance, particularly the stable SI performance.

It is to be understood that the term “comprises”, “comprising”, or any other variants thereof, is intended to encompass a non-exclusive inclusion, such that a process, method, article, or device of a series of elements not only comprise those elements but further comprises other elements that are not explicitly listed, or elements that are inherent to such a process, method, article, or device. An element defined by the phrase “comprising a . . . ” does not exclude the presence of the same element in the process, method, article, or device that comprises the element.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

What is claimed is:

1. An electric cable, comprising:
two signal conductors;
a resin insulating layer covering the two signal conductors;
an expanded polytetrafluoroethylene insulating film covering the resin insulating layer;
an electromagnetic shielding film covering the expanded polytetrafluoroethylene insulating film;
two ground conductors disposed at the periphery of the electromagnetic shielding film; and
a cladding layer cladding the electromagnetic shielding film and the two ground conductors.

2. The electric cable according to claim 1, wherein the centers of the two ground conductors are on a line connecting with the centers of the two signal conductors.

3. The electric cable according to claim 1, wherein the centers of the two ground conductors are offset relative to the line connecting with the centers of the two signal conductors; the centers of the two ground conductors are on the same side of the line connecting with the centers of the two signal conductors.

4. The electric cable according to claim 1, wherein the centers of the two ground conductors are offset relative to the line connecting with the centers of the two signal conductors; the centers of the two ground conductors are on two sides of the line connecting with the centers of the two signal conductors.

5. The electric cable according to claim 1, wherein the thickness of the resin insulating layer is thicker than or equal to the thickness of the expanded polytetrafluoroethylene insulating film.

6. The electric cable according to claim 1, wherein the thickness of the resin insulating layer is thinner than or equal to the outer diameter of any one of the two signal conductors.

7. The electric cable according to claim 1, wherein at least one first elastic deformation space is provided between the expanded polytetrafluoroethylene insulating film and the resin insulating layer.

8. The electric cable according to claim 1, wherein a plurality of second elastic deformation spaces are provided between the cladding layer, the electromagnetic shielding film, and the two ground conductors.

9. The electric cable according to claim 1, wherein the electromagnetic shielding film comprises a single electromagnetic shielding film layer; the material of the electromagnetic shielding film layer is selected from a group comprising aluminum, copper, lead, and tin.

10. The electric cable according to claim 1, wherein the electromagnetic shielding film comprises two connecting parts; the two connecting parts are respectively disposed at two ends of the electromagnetic shielding film and are connected in a stacked manner.

11. The electric cable according to claim 1, wherein the expanded polytetrafluoroethylene insulating film comprises two positioning recesses in which the two ground conductors are respectively disposed; the electromagnetic shielding film is disposed between the two ground conductors and the two positioning recesses.

12. The electric cable according to claim 1, wherein the electromagnetic shielding film comprises:
an insulating isolation layer covering the expanded polytetrafluoroethylene insulating film;
a first electromagnetic shielding film layer disposed on an inner surface of the insulating isolation layer; the first electromagnetic shielding film layer is disposed between the expanded polytetrafluoroethylene insulating film and the insulating isolation layer; and
a second electromagnetic shielding film layer disposed on an outer surface of the insulating isolation layer; the first electromagnetic shielding film layer and the second electromagnetic shielding film layer are oppositely disposed and are partially overlapped; the first electromagnetic shielding film layer and the second electromagnetic shielding film layer are disposed around the two signal conductors; the two ground conductors are in contact with the second electromagnetic shielding film layer.

13. The electric cable according to claim 12, wherein the first electromagnetic shielding film layer comprises a first covering part and two first cladding parts; the two first cladding parts are disposed on two sides of the first covering part; a first gap corresponding to the first covering part exists between the two first cladding parts; the second electromagnetic shielding film layer comprises a second covering part and two second cladding parts; the two second cladding parts are disposed on two sides of the second covering part; a second gap corresponding to the second covering part exists between the two second cladding parts; the second covering part covers the first gap; the two first cladding parts partially overlap with the two second cladding parts respectively.

14. The electric cable according to claim 13, wherein the two first cladding parts are respectively arc-shaped; a central angle of any one of the two first cladding parts is greater than 10 degrees and smaller than 180 degrees; the two second cladding parts are respectively arc-shaped; a central angle of any one of the two second cladding parts is greater than 10 degrees and smaller than 180 degrees.

15. The electric cable according to claim 12, wherein the material of the first electromagnetic shielding film layer is selected from a group comprising aluminum, copper, lead, and tin; the material of the second electromagnetic shielding film layer is selected from a group comprising aluminum, copper, lead, and tin; the material of the insulating isolation layer is polyester.

16. The electric cable according to claim 1, wherein the resin insulating layer is made of polyethylene, polypropylene, or ethylene propylene fluoride.

17. The electric cable according to claim 1, wherein the material of the two signal conductors is selected from a group comprising copper, aluminum, tin, nickel, silver, and gold; the material of the two ground conductors is selected from a group comprising copper, aluminum, tin, nickel, silver, and gold; the material of the cladding layer is polyester.
